(19) United States
(12) Patent Application Publication
(10) Pub. No.: US 2025/0378404 A1
(43) Pub. Date: Dec. 11, 2025

(54) WORKFLOW CREATION

(71) Applicant: Beijing Zitiao Network Technology Co., Ltd., Beijing (CN)

(72) Inventor: Xuneng Huang, Beijing (CN)

(21) Appl. No.: 18/821,017

(22) Filed: Aug. 30, 2024

(30) Foreign Application Priority Data
Jun. 7, 2024 (CN) 202410741568.2

(51) Int. Cl. G06Q 10/0631; G06F 16/901

(52) U.S. Cl. CPC G06Q 10/06316; G06F 16/9024

(57) ABSTRACT

Methods, devices, and storage media for workflow creation are provided. A method includes: in response to a received editing operation, adding a first node corresponding to a text processing node to a node connection graph; obtaining configuration information for the first node via a set of input controls associated with the first node, the configuration information indicating a text processing process corresponding to the first node; and creating a target workflow based on the node connection graph.

### CROSS-REFERENCE

This application claims the benefit of Chinese Patent Application No. 202410741568.2 filed on Jun. 7, 2024, entitled “METHOD AND APPARATUS FOR CREATING WORKFLOW, DEVICE AND STORAGE MEDIUM”, which is hereby incorporated by reference in its entirety.

### FIELD

Example embodiments of the present disclosure generally relate to the field of computers, and more particularly, to workflow creation.

### BACKGROUND

With the development of computer technology, people may create and release various types of applications through various platforms. In an application development process, the creation and management of workflows is an important task. For example, a user may indicate a process flow for a request by editing nodes in a workflow.

### SUMMARY

In a first aspect of the present disclosure, a method for creating a workflow is provided. The method includes: in response to a received editing operation, adding a first node corresponding to a text processing node to a node connection graph; obtaining configuration information for the first node via a set of input controls associated with the first node, the configuration information indicating a text processing process corresponding to the first node; and creating a target workflow based on the node connection graph.

In a second aspect of the present disclosure, there is provided an electronic device, the device includes at least one processing unit; and at least one memory, the at least one memory being coupled to the at least one processing unit and storing instructions for execution by the at least one processing unit. The instructions, when executed by the at least one processing unit, cause the device to perform operations that implement the method of the first aspect.

In a third aspect of the present disclosure, there is provided a computer readable storage medium, where the computer readable storage medium stores a computer program thereon, and the computer program is executable by a processor to perform operations that implement the method of the first aspect.

It should be appreciated that the content described in this section is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment.

FIG. 2 illustrates a flow diagram of an example process for creating a workflow.

FIG. 3 illustrates an example editing interface.

FIG. 4 illustrates a schematic structural block diagram of an example apparatus for creating a workflow.

FIG. 5 illustrates a block diagram of an example electronic device capable of implementing various embodiments of the present disclosure.

### DETAILED DESCRIPTION

Embodiments of the present disclosure will be described in more detail below with reference to the accompanying drawings. Although certain embodiments of the present disclosure are illustrated in the accompanying drawings, it should be understood that, the present disclosure may be implemented in various forms and should not be construed as limited to the embodiments set forth herein. On the contrary, these embodiments are provided for a more thorough and complete understanding of the present disclosure. It should be understood that, the drawings and embodiments of the present disclosure are provided for illustrative purposes only and are not intended to limit the scope of protection of the present disclosure.

It should be noted that the headings of any section/subsection provided herein are not limiting. Various embodiments are described throughout herein, and any type of embodiments can be included under any section/subsection. Furthermore, embodiments described in any section/subsection may be combined in any manner with any other embodiments described in the same section/subsection and/or different sections/subsections.

In the description of the embodiments of the present disclosure, the term “including” and the like should be understood as non-exclusive inclusion, that is, “including but not limited to”. The term “based on” should be read as “based at least in part on”. The term “one embodiment” or “the embodiment” should be read as “at least one embodiment”. The term “some embodiments” should be understood as “at least some embodiments”. Other explicit and implicit definitions may also be included below. The terms “first”, “second”, etc. may refer to different or identical objects. Other explicit and implicit definitions may also be included below.

Embodiments of the present disclosure may relate to data, acquisition and/or use of data, etc. by a user. These aspects shall follow respective legal regulations and related regulations. In embodiments of the present disclosure, all data collection, acquisition, processing, forwarding, usage, and the like, are carried out with user knowledge and confirmation. Accordingly, when implementing the embodiments of the present disclosure, the user should be informed of the types of data or information that may be involved, a usage range, a usage scenario, and the like in an appropriate manner according to relevant legal regulations, and the authorization of the user shall be obtained. The specific informing and/or authorization manner may vary according to actual situations and application scenarios, and the scope of the present disclosure is not limited in this aspect.

In the present description and the embodiments, if personal information processing is involved, the processing is performed on the basis of legitimacy (for example, the consent of subject of the personal information is obtained, or necessary for fulfillment of a contract, etc.), and will be performed only within a prescribed range or a predetermined range. The user rejecting to process personal information other than necessary information required for processing the basic function will not affect the user in using the basic function.

Traditionally, users may quickly create a workflow, for example, by configuring different processing nodes in the workflow. However, in such a workflow creation process, people need to edit code to achieve text processing, which affects the efficiency of workflow development.

Embodiments of the present disclosure provide a workflow creation solution. According to the solution, a first node for text processing can be added to a node connection graph in response to the received editing operation. Further, configuration information for the first node may be obtained via a set of input controls associated with the first node, the configuration information is configured for indicating a text processing process corresponding to the first node. Accordingly, a target workflow can be created based on the node connection graph.

Thus, embodiments of the present disclosure can support the configuration of a text processing process of the workflow when processing a request by adding the text processing node, thereby improving the efficiency of workflow development.

Various example implementations of the solution are described in further detail below with reference to the accompanying drawings.

### Example Environment

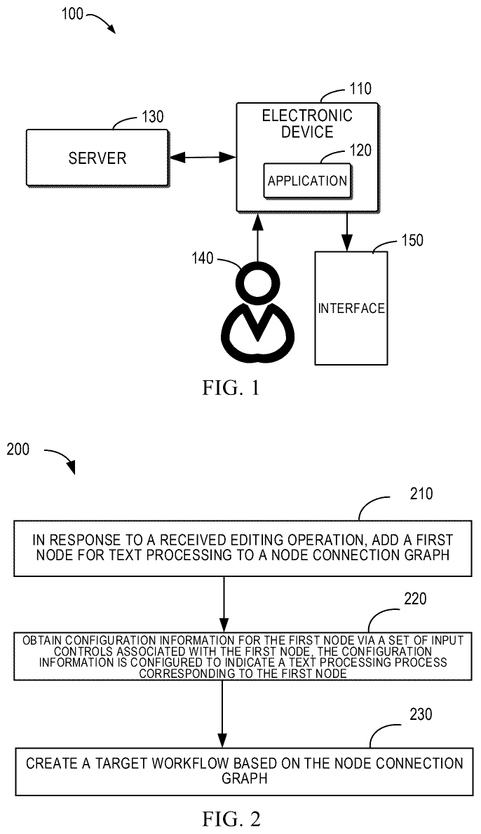

FIG. 1 illustrates a schematic diagram of an example environment 100 in which embodiments of the present disclosure can be implemented. As illustrated in FIG. 1, the example environment 100 can include an electronic device 110.

In this example environment 100, the electronic device 110 can run an application 120 that supports interface interaction. The application 120 can be any suitable type of application for interface interaction, examples of which can include, but are not limited to, a development application or other suitable application that supports workflow creation. The user 140 may interact with the application 120 via the electronic device 110 and/or an attachment device thereof.

In an environment 100 of FIG. 1, if the application 120 is active, the electronic device 110 may present an interface 150 for supporting creation of a workflow through the application 120.

In some embodiments, the electronic device 110 communicates with a server 130 to enable the provision of services to the application 120. The electronic device 110 may be any suitable type of electronic device including, e.g., a mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, and a Personal Communication System, a PCS) device, a personal navigation device, a personal digital assistant (PDA), an audio/video player, a digital camera/camcorder, a positioning device, a television receiver, a radio broadcast receiver, an electronic book device, game device, or any combination of the foregoing, including accessories and peripherals for these devices, or any combination thereof. In some embodiments, the electronic device 110 can also support the provision of any suitable type of interface to a user (such as a “wearable” circuit or the like).

The server 130 may be an independent physical server, may also be a server cluster or a distributed system formed by a plurality of physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, etc. The server 130 may provide background services for the application 120 that supports a virtual scene in the electronic device 110.

A communication connection may be established between the server 130 and the electronic device 110. The communication connection may be established in a wired manner or a wireless manner. Communication connections may include, but are not limited to, Bluetooth connections, mobile network connections, Universal Serial Bus (USB) connections, Wireless Fidelity (WiFi) connections, and the like, the embodiments of the present disclosure are not limited in this regard. In embodiments of the present disclosure, the server 130 and the electronic device 110 may implement signaling interaction through a communication connection therebetween.

It should be understood that the structure and function of the various elements in environment 100 are described for exemplary purposes only, and are not intended to imply any limitation on the scope of the disclosure.

Some example embodiments of the present disclosure will be described below by continuously referring to the accompanying drawings.

### Example Process

FIG. 2 illustrates a flowchart of a process 200 for creating a workflow according to some embodiments of the disclosure. In the context of the present disclosure, “creating a workflow” may be implemented in a variety of forms. For example, a new workflow may be created using the example process 200, or an existing workflow may also be opened and edited using an editing interface as described below. The process 200 can be implemented at electronic device 110. The process 200 will be described below with reference to FIG. 1.

As illustrated in FIG. 2, at block 210, in response to a received editing operation, the electronic device 110 adds a first node for text processing to a node connection graph.

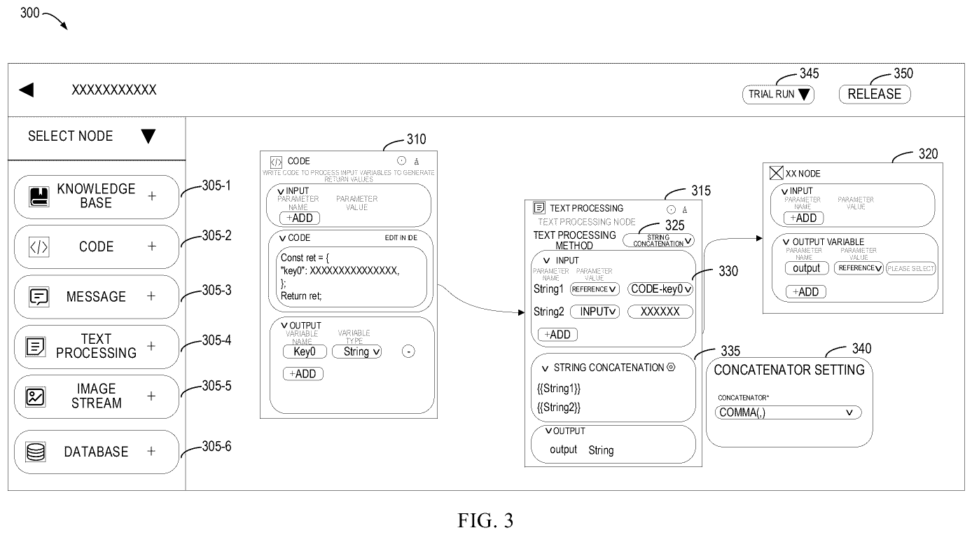

The process 200 will be described below with reference to FIG. 3. FIG. 3 illustrates an example editing interface 300 according to some embodiments of the present disclosure.

As illustrated in FIG. 3, the interface 300 may be a node editing interface for creating the workflow. As illustrated, the electronic device 110 may present, in the interface 300, a plurality of interface elements that correspond to a plurality of node types, e.g., the interface element 305-1 to the interface element 305-6. As an example, the interface element 305-1 may be used to add a knowledge base node, the interface element 305-2 may be used to add a code node, the interface element 305-3 may be used to add a message node, the interface element 305-4 may be used to add a text processing node, the interface element 305-5 may be used to add an image stream node, and the interface element 305-6 may be used to add a database node.

In some embodiments, in addition to the above specific nodes, the embodiments of the present disclosure may also support addition of other suitable types of nodes. For example, the electronic device 110 can support the user to add another created workflow as a single processing node into the node connection graph.

As an example, the electronic device 110 may receive the user's selection of the interface element 305-4, to add the first node 315 to the node connection graph. The first node 315 is also referred to as a text processing node.

At block 220, the electronic device 110 obtains configuration information for the first node 315 via a set of input controls associated with the first node. The configuration information is configured to indicate the text processing process corresponding to the first node.

In some embodiments, the configuration information for the first node 315 may indicate the processing type of the text processing process corresponding to the first node 315. As illustrated in FIG. 3, the electronic device 110 may provide a first input control 325 for configuring the process type.

As an example, the electronic device 110 may present a set of supported candidate types based on triggering on the input control 325. The set of candidate types may correspond to different text processing processes, examples of which may include, but are not limited to, string concatenation, string splitting, text substitution, string word counting, text format conversion, text verification, and the like.

As illustrated in FIG. 3, for example, the electronic device 110 may receive a user's selection of the type “string concatenation” via the input control 325, and determine that the first node 315 corresponds to a string concatenation process.

In some embodiments, the configuration information for the first node 315 may also indicate the input parameter of the text processing process. As illustrated in FIG. 3, the electronic device 110 may provide a second input control 330 for configuring the input parameter.

In some embodiments, the second input control 330 can support the user in configuring the input parameter through referencing a target data object of the second node associated with the first node 315.

Taking FIG. 3 as an example, in the case where the user selects a data source as “reference”, the electronic device 110 may present at least one node associated with the first node 315 in the second input control 330. Such at least one node may include, for example, one or more upstream nodes (e.g., the second node 310) of the first node 315.

Further, the electronic device 110 can, for example, receive a user's selection of second node 310 and can accordingly present one or more data objects associated with the second node 310. In some embodiments, such one or more data objects may include the data object defined during the processing of the second node 310 or, the output data object.

In some embodiments, for example, the electronic device 110 may also screen or filter specific data objects based on the type of the text processing process. For example, when the text processing process involves processing of the string, the electronic device 110 may, for example, merely display data objects that contain the string.

Further, the electronic device 110 may receive a user's selection of a target data object in the set of data objects and may configure the input parameters accordingly. Taking FIG. 3 as an example, the electronic device 110 may complete the configuration of the input parameter “String 1”, e.g., based on the user's selection of the target data object “key0”. In this way, the value of the input parameter “String 1” will be determined based on the target data object “key0”.

In some embodiments, the second input control 330 may also support the definition of the new input parameter. For example, in the case where the user selects the data source as “input”, the user may configure the value of the input parameter “String 2” via the second input control 330.

In some embodiments, the configuration information for the first node 315 may also indicate at least one operator of the text processing process. As illustrated in FIG. 3, for example, the electronic device 110 may receive the user's selection of a setting button in the fourth input control 335, and may accordingly display the third input control 340 for configuring at least one operator.

In some embodiments, the third input control 340 may correspond to the text processing type of the first node 315. For example, in the case where the first node 315 corresponds to “string concatenation”, the third input control 340 may be used to configure a “concatenator” for “string concatenation”. As another example, in the case where the first node 315 corresponds to “string splitting”, the third input control 340 may be used to configure one or more “splitter” for “string splitting”.

As an example, the third input control 340 may, for instance, indicate the user to select one or more operators from a set of preset operators. Alternatively, the third input control 340 may also, for example, support a user to freely input a specific operator.

In some embodiments, the configuration information for the first node 315 may also indicate an expression corresponding to the text processing process. As illustrated in FIG. 3, the electronic device 110 may provide the fourth input control 335 for inputting the expression. In some embodiments, the expression may indicate a specific operation process for text processing, which may be expressed, for example, by way of appropriate non-programming code.

Taking “string concatenation” as an example, the fourth input control 335, for example, obtains the expression input by the user to define a specific concatenation order of “string concatenation”. Taking FIG. 3 as an example, the user may input an expression via the fourth input control 335 to specify that the processing process of “string concatenation” is to connect the input parameters “String 1” and “String 2” using the specified concatenator (e.g., comma). In some embodiments, the fourth input control 335, for example, may also support the user to freely input other character content to be concatenated, etc.

Based on the above configuration process, the embodiments of the present disclosure can support the user to conveniently configure the text processing process of the workflow in a graphical manner, thereby improving the efficiency of workflow development.

In some embodiments, the electronic device 110 may also connect, in the node connection graph, an output of the first node 315 to the inputs of one or more third nodes 320 based on the received connection operation. Accordingly, in the processing process of the target workflow, the output result of the text processing process of the first node 315 will be provided as the input of the third node 320.

At block 230, the electronic device 110 creates a target workflow based on the node connection graph.

In some embodiments, upon completing editing of the node connection graph, the electronic device 110 may trigger the corresponding debugging process, e.g., based on the control 345. Additionally, the electronic device 110 may also create and release the corresponding target workflow based on the triggering of the control 350.

As an example, the electronic device 110 can create the corresponding target workflow based on configuration information for the nodes and the connection between the nodes in the node connection graph. Such target workflows, for example, can be released or shared to other users.

In some embodiments, such a target workflow may be released independently, or the creation and release of the application based on the target workflow (e.g., a robot program bot or an agent) may be triggered.

Based on the process described above, the embodiments of the present disclosure can support configuring a text processing process of the workflow when processing a request by adding the text processing node, thereby improving the efficiency of workflow development.

### Example Apparatus and Device

Embodiments of the present disclosure also provide a corresponding apparatus for implementing the above described method or process. FIG. 4 illustrates a schematic structural block diagram of an example apparatus 400 for creating a workflow according to some embodiments of the present disclosure. The apparatus 400 may be implemented as or included in an electronic device 110. The various modules/components in the apparatus 400 may be implemented by hardware, software, firmware, or any combination thereof.

As illustrated in FIG. 4, the apparatus 400 includes: an adding module 410 configured to add a first node corresponding to a text processing node to the node connection graph in response to the received editing operation; an obtaining module 420 configured to obtain configuration information for the first node via a set of input controls associated with the first node, the configuration information indicating a text processing process corresponding to the first node; and a creating module 430 configured to create a target workflow based on the node connection graph.

In some embodiments, the adding module 410 is further configured to: present a plurality of interface elements corresponding to a plurality of node types; and in response to a selection of a target interface element in the plurality of interface elements, add the first node to the node connection graph. The target interface element corresponds to the text processing node.

In some embodiments, the obtaining module 420 is further configured to: present, in a first input control of the set of input controls, a set of candidate types; and determine, based on a selection of a target type in the set of candidate types, a processing type of the text processing process corresponding to the first node.

In some embodiments, the obtaining module 420 is further configured to obtain an input parameter of the text processing process via a second input control in the set of input controls.

In some embodiments, the input parameter includes a first input parameter and/or a second input parameter, the first input parameter is configured through referencing a target data object in a second node associated with the first node, the second input parameter is defined via the second input control.

In some embodiments, the obtaining module 420 is further configured to: present, in the second input control, at least one node associated with the first node; in response to a selection of the second node in the at least one node, present a set of data objects associated with the second node; and configure the first input parameter based on a selection of the target data object in the set of data objects.

In some embodiments, the obtaining module 420 is further configured to obtain at least one operator associated with the text processing process via a third input control in the set of input controls. The third input control corresponds to a processing type of the text processing process.

In some embodiments, the obtaining module 420 is further configured to obtain an expression corresponding to the text processing process via a fourth input control in the set of input controls.

In some embodiments, apparatus 400 further includes a connecting module. The connecting module is configured to connect, in the node connection graph, an output of the first node to an input of a third node, to indicate that an output result of the text processing process of the first node is provided as an input of the third node.

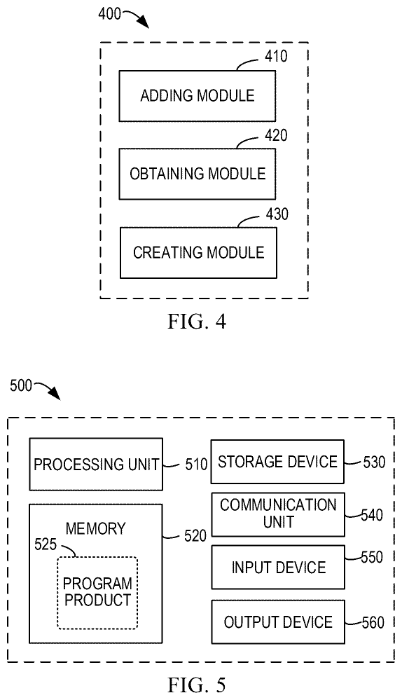

FIG. 5 illustrates a block diagram of an electronic device 500 in which one or more embodiments of the present disclosure can be implemented. It should be appreciated that the electronic device 500 illustrated in FIG. 5 is merely exemplary and should not constitute any limitation on the functionality and scope of the embodiments described herein. The electronic device 500 illustrated in FIG. 5 may be used to implement the electronic device 110 of FIG. 1.

As illustrated in FIG. 5, the electronic device 500 is in the form of a general-purpose electronic device. Components of the electronic device 500 may include, but are not limited to, one or more processors or processing units 510, a memory 520, a storage device 530, one or more communications units 540, one or more input devices 550, and one or more output devices 560. The processing unit 510 may be an actual or virtual processor and can perform various processes according to programs stored in the memory 520. In a multiprocessor system, a plurality of processing units execute computer executable instructions in parallel, to improve the parallel processing capability of the electronic device 500.

The electronic device 500 typically includes a plurality of computer storage media. Such media may be any available media that are accessible by electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium such as a flash drive, a magnetic disk, or any other medium that can be used to store information and/or data and that can be accessed within the electronic device 500.

The electronic device 500 may further include additional removable/non-removable, volatile/nonvolatile storage media. Although not illustrated in FIG. 5, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines, and these computing machines can communicate through a communication connection. Thus, the electronic device 500 may operate in a networked environment using logical connections to one or more other servers, network personal computers (PCs), or another network node.

The input device 550 may be one or more input devices such as a mouse, keyboard, trackball, etc. The output device 560 may be one or more output devices such as a display, speaker, printer, etc. The electronic device 500 may also communicate with one or more external devices (not shown) such as a storage device, a display device, or the like through the communication unit 540 as required, and communicate with one or more devices that enable a user to interact with the electronic device 500, or communicate with any device (e.g., a network card, a modem, or the like) that enables the electronic device 500 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to perform the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

1. A method for creating a workflow, comprising:
in response to a received editing operation, adding a first node corresponding to a text processing node to a node connection graph;
obtaining configuration information for the first node via a set of input controls associated with the first node, the configuration information indicating a text processing process corresponding to the first node; and
creating a target workflow based on the node connection graph.

2. The method of claim 1, wherein adding the first node to the node connection graph in response to the received editing operation comprises:
presenting a plurality of interface elements corresponding to a plurality of node types; and
in response to a selection of a target interface element of the plurality of interface elements, adding the first node to the node connection graph, the target interface element corresponding to the text processing node.

3. The method of claim 1, wherein obtaining the configuration information for the first node via the set of input controls associated with the first node comprises:
presenting, in a first input control of the set of input controls, a set of candidate types; and
determining, based on a selection of a target type in the set of candidate types, a processing type of the text processing process corresponding to the first node.

4. The method of claim 1, wherein obtaining the configuration information for the first node via the set of input controls associated with the first node comprises:
obtaining an input parameter of the text processing process via a second input control in the set of input controls.

5. The method of claim 4, wherein the input parameter comprises:
a first input parameter, the first input parameter being configured through referencing a target data object in a second node associated with the first node, and/or
a second input parameter, the second input parameter being defined via the second input control.

6. The method of claim 5, wherein obtaining the input parameter of the text processing process via the second input control in the set of input controls comprises:
presenting, in the second input control, at least one node associated with the first node;
in response to a selection of the second node in the at least one node, presenting a set of data objects associated with the second node; and
configuring the first input parameter based on a selection of the target data object in the set of data objects.

7. The method of claim 1, wherein obtaining the configuration information for the first node via the set of input controls associated with the first node comprises:
obtaining at least one operator associated with the text processing process via a third input control in the set of input controls, wherein the third input control corresponds to a processing type of the text processing process.

8. The method of claim 1, wherein obtaining the configuration information for the first node via the set of input controls associated with the first node comprises:
obtaining an expression corresponding to the text processing process via a fourth input control in the set of input controls.

9. The method of claim 1, further comprising:
connecting, in the node connection graph, an output of the first node to an input of a third node, to indicate that an output result of the text processing process of the first node is provided as an input of the third node.

10. An electronic device, comprising:
at least one processing unit; and
at least one memory, the at least one memory being coupled to the at least one processing unit and storing instructions for execution by the at least one processing unit, and the instructions, when executed by the at least one processing unit, cause the electronic device to perform operations comprising:
in response to a received editing operation, adding a first node corresponding to a text processing node to a node connection graph;
obtaining configuration information for the first node via a set of input controls associated with the first node, the configuration information indicating a text processing process corresponding to the first node; and
creating a target workflow based on the node connection graph.

11. The electronic device of claim 10, wherein adding the first node to the node connection graph in response to the received editing operation comprises:
presenting a plurality of interface elements corresponding to a plurality of node types; and
in response to a selection of a target interface element of the plurality of interface elements, adding the first node to the node connection graph, the target interface element corresponding to the text processing node.

12. The electronic device of claim 10, wherein obtaining the configuration information for the first node via the set of input controls associated with the first node comprises:
presenting, in a first input control of the set of input controls, a set of candidate types; and
determining, based on a selection of a target type in the set of candidate types, a processing type of the text processing process corresponding to the first node.

13. The electronic device of claim 10, wherein obtaining the configuration information for the first node via the set of input controls associated with the first node comprises:
obtaining an input parameter of the text processing process via a second input control in the set of input controls.

14. The electronic device of claim 13, wherein the input parameter comprises:
a first input parameter, the first input parameter being configured through referencing a target data object in a second node associated with the first node, and/or
a second input parameter, the second input parameter being defined via the second input control.

15. The electronic device of claim 14, wherein obtaining the input parameter of the text processing process via the second input control in the set of input controls comprises:
presenting, in the second input control, at least one node associated with the first node;
in response to a selection of the second node in the at least one node, presenting a set of data objects associated with the second node; and
configuring the first input parameter based on a selection of the target data object in the set of data objects.

16. The electronic device of claim 10, wherein obtaining the configuration information for the first node via the set of input controls associated with the first node comprises:
obtaining at least one operator associated with the text processing process via a third input control in the set of input controls, wherein the third input control corresponds to a processing type of the text processing process.

17. The electronic device of claim 10, wherein obtaining the configuration information for the first node via the set of input controls associated with the first node comprises:
obtaining an expression corresponding to the text processing process via a fourth input control in the set of input controls.

18. The electronic device of claim 10, the operations further comprising:
connecting, in the node connection graph, an output of the first node to an input of a third node, to indicate that an output result of the text processing process of the first node is provided as an input of the third node.

19. A non-transitory computer readable storage medium comprising a computer program stored thereon, wherein the computer program is executable by a processor to cause to the processor to perform operations comprising:
in response to a received editing operation, adding a first node corresponding to a text processing node to a node connection graph;
obtaining configuration information for the first node via a set of input controls associated with the first node, the configuration information indicating a text processing process corresponding to the first node; and
creating a target workflow based on the node connection graph.

20. The non-transitory computer readable storage medium of claim 19, wherein adding the first node to the node connection graph in response to the received editing operation comprises:
presenting a plurality of interface elements corresponding to a plurality of node types; and
in response to a selection of a target interface element of the plurality of interface elements, adding the first node to the node connection graph, the target interface element corresponding to the text processing node.
